(19) United States
(12) Patent Application Publication
(10) Pub. No.: US 2007/0256009 A1
(43) Pub. Date: Nov. 1, 2007

(54) METHOD AND APPARATUS FOR GENERATING XHTML DATA

(75) Inventor: Eun-hui JUNG, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/686,653

(22) Filed: Mar. 15, 2007

Related U.S. Application Data
(60) Provisional application No. 60/791,410, filed on Apr. 13, 2006.

(30) Foreign Application Priority Data
May 12, 2006 (KR) 2006-43131

(51) Int. Cl. G06F 17/00

(52) U.S. Cl. 715/513

(57) ABSTRACT

A method of generating extensible hypertext markup language (XHTML) data in a device generating XHTML data, the method including determining whether overlapping objects exist in XHTML data generated by the device; determining whether all of the overlapping objects have distinctiveness; and correcting a style of at least one overlapping object determined not to have distinctiveness among the overlapping objects.

### CROSS-REFERENCE TO RELATED APPLICATIONS

This application claims the benefit of U.S. Provisional Patent Application No. 60/791,410 filed on Apr. 13, 2006, in the U.S. Patent and Trademark Office, and Korean Patent Application No. 10-2006-0043131 filed on May 12, 2006, in the Korean Intellectual Property Office, the disclosures of which are incorporated herein by reference in their entirety.

### BACKGROUND OF THE INVENTION

1. Field of the Invention

An aspect of the invention relates to a device, and more particularly to a method and apparatus for generating extensible hypertext markup language (XHTML)-Print data using markup language in a device.

2. Description of the Related Art

A device generates print data by using a markup language, such as XHTML-Print, and transmits the generated print data to an image forming apparatus, and the print data received from the device is printed by the image forming apparatus.

Style information in a template to support outputting of XHTML-Print data is generally set to a fixed value. Thus, even in a case where distinctiveness between overlapping objects is low, such as in part 100 in FIG. 1 in which a text object is disposed on an image object having a color similar to that of the text object, the device transmits the print data in its original state without correction to the image forming apparatus which prints the print data, and thus the quality of the printing is degraded.

In order to solve this problem caused by setting the style information to a fixed value, a user can be allowed to input style information included in a template.

For example, by receiving from the user an input of a color value of a text object disposed on an image object, distinctiveness of an overlapping object can be determined in advance and then printing can be requested if the overlapping object has distinctiveness. However, in order for the user to determine whether an object changed by input style information has distinctiveness, a preview function should be provided, and images to provide the preview function should be stored in a device having quite limited resources so that the usage amount of the limited resources increases.

In addition, although the preview function may be provided, the user has to inconveniently input style information each time he wants to print in order to print data using the device.

### SUMMARY OF THE INVENTION

An aspect of the invention provides an XHTML data generation method and apparatus that detects an overlapping object having low distinctiveness in XHTML-Print data generated by a device, automatically corrects the style of the overlapping object so that the distinctiveness of the overlapping object is enhanced, and applies the corrected style to the XHTML-Print data to generate corrected XHTML-Print data.

According to an aspect of the invention, there is provided a method of generating extensible hypertext markup language (XHTML) data in a device generating XHTML data, the method including determining whether overlapping objects exist in XHTML data generated by the device; determining whether the overlapping objects have distinctiveness; and correcting a style of at least one overlapping object determined not to have distinctiveness among the overlapping objects.

The method may further include applying the corrected style of the at least one overlapping object to the XHTML data to generate corrected XHTML data.

The correcting of the style may include correcting a color of the at least one overlapping object.

The correcting of the color may include correcting the color of the at least one overlapping object to be complementary to a color of a background of the at least one overlapping object.

The correcting of the style may include correcting a background of the at least one overlapping object.

The correcting of the style may include cropping the at least one overlapping object.

The correcting of the style may include moving a position of the at least one overlapping object.

The correcting of the style may include automatically correcting the style of the at least one overlapping object without requiring an input from a user of the device.

The determining of whether all of the overlapping objects have distinctiveness may include comparing a color value of each one of the overlapping objects with a color value of each other one of the overlapping objects that overlaps the each one of the overlapping objects.

According to another aspect of the invention, there is provided a computer readable medium encoded with processing instructions for implementing a method according to an aspect of the invention performed by a computer.

According to another aspect of the invention, there is provided an apparatus for generating extensible hypertext markup language (XHTML) data in a device generating XHTML data, the apparatus including a distinctiveness determination unit that determines whether overlapping objects exist in XHTML data generated by the device, and determines whether all of the overlapping objects have distinctiveness; a style correction unit that corrects a style of at least one overlapping object determined not to have distinctiveness among the overlapping objects; and an XHTML data generation unit that applies the corrected style of the at least one overlapping object to the XHTML data to generate corrected XHTML data.

The style correction unit may correct the style by correcting a color of the at least one overlapping object.

The style correction unit may correct the color by correcting the color of the at least one overlapping object to be complementary to a color of a background of the at least one overlapping object.

The style correction unit may correct the style by correcting a background of the at least one overlapping object.

The style correction unit may correct the style by cropping the at least one overlapping object.

The style correction unit may correct the style by moving a position of the at least one overlapping object.

The style correction unit may correct the style by automatically correcting the style of the at least one overlapping object without requiring an input from a user of the device.

The distinctiveness determination unit may determine whether all of the overlapping objects have distinctiveness by comparing a color value of each one of the overlapping objects with a color value of each other one of the overlapping objects that overlaps the each one of the overlapping objects.

According to another aspect of the invention, there is provided a method of generating extensible hypertext markup language (XHTML) data in a device generating XHTML data, the method including determining whether all of overlapping objects existing in XHTML data generated by the device have distinctiveness; automatically correcting a style of a sufficient number of the overlapping objects so that all of the overlapping objects have distinctiveness; and applying the corrected style of the sufficient number of the overlapping objects to the XHTML data to generate corrected XHTML data.

According to another aspect of the invention, there is provided an apparatus for generating extensible hypertext markup language (XHTML) data in a device generating XHTML data, the apparatus including a distinctiveness determination unit that determines whether all of overlapping objects existing in XHTML data generated by the device have distinctiveness; a style correction unit that automatically corrects a style of a sufficient number of the overlapping objects so that all of the overlapping objects have distinctiveness; and an XHTML data generation unit that applies the corrected style of the sufficient number of the overlapping objects to the XHTML data to generate corrected XHTML data.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the invention will become apparent and more readily appreciated from the following description of embodiments of the invention, taken in conjunction with the accompanying drawings of which:

FIG. 1 illustrates an example in which a text object is disposed on an image object having a color similar to that of the text object;

FIG. 2 is a flowchart of a method of generating XHTML data according to an aspect of the invention;

FIG. 3 is a flowchart of an operation of correcting the color of an object to complementary to the color of a background according to an aspect of the invention;

FIG. 4 is a block diagram of an XHTML data generation apparatus according to an aspect of the invention;

FIG. 5A illustrates an example in which a text object overlaps a background object according to an aspect of the invention;

FIG. 5B illustrates an example in which the color value of the text object of FIG. 5A is compared with the color value of the overlapped background object of FIG. 5A to determine distinctiveness of the text object according to an aspect of the invention;

FIG. 6A illustrates an example in which a text object overlaps an image object according to an aspect of the invention;

FIG. 6B illustrates an example in which a histogram of the color value of the text object of FIG. 6A is compared with a histogram of the color value of the overlapped image object of FIG. 6A to determine distinctiveness of the text object according to an aspect of the invention;

FIG. 7A illustrates an example in which a text object does not have distinctiveness in relation to a background according to an aspect of the invention;

FIG. 7B illustrates an example in which the color of the text object of FIG. 7A has been corrected to be complementary to the color of the background of FIG. 7A according to an aspect of the invention;

FIG. 7C illustrates an example of XHTML code for correcting the color of the text object of FIG. 7A to be complementary to the color of the background of FIG. 7A according to an aspect of the invention;

FIG. 8A illustrates an example in which a text object does not have distinctiveness in relation to a background according to an aspect of the invention;

FIG. 8B illustrates an example in which the color of the text object of FIG. 8A has been corrected to be complementary to the color of the background of FIG. 8A according to an aspect of the invention;

FIGS. 8C and 8D illustrate examples of XHTML code for correcting the color of the text object of FIG. 8A to be complementary to the color of the background of FIG. 8A according to an aspect of the invention;

FIG. 9A illustrates an example in which it is difficult to distinguish a text object from a background or a portion of an image object serving as a background according to an aspect of the invention;

FIG. 9B illustrates an example in which the color of the background of FIG. 9A has been corrected to ‘yellow’ according to an aspect of the invention;

FIG. 9C illustrates an example of XHTML code for correcting the color of the background of FIG. 9A to ‘yellow’ according to an aspect of the invention;

FIG. 9D illustrates an example in which the color of the background of FIG. 9A has been corrected to ‘white’ according to an aspect of the invention;

FIG. 9E illustrates an example of XHTML code for correcting the color of the background of FIG. 9A to ‘white’ according to an aspect of the invention;

FIG. 10A illustrates an example in which overlapping text and image objects have no distinctiveness according to an aspect of the invention;

FIG. 10B illustrates an example in which 20% of the image object of FIG. 10A has been cropped at the bottom of the image object so that the distinctiveness of the text object of FIG. 10A is enhanced according to an aspect of the invention;

FIG. 10C illustrates an example of XHTML code for cropping 20% of the image object of FIG. 10A at the bottom of the image object according to an aspect of the invention;

FIG. 11A illustrates an example in which overlapping text and image objects have no distinctiveness according to an aspect of the invention;

FIG. 11B illustrates an example in which the text object of FIG. 11A having no distinctiveness is corrected by moving the position of the text object to a position below the image object of FIG. 11A so that the distinctiveness of the text object is enhanced according to an aspect of the invention;

FIG. 11C illustrates an example of XHTML code for moving the position of the text object of FIG. 11A below the image object of FIG. 11A according to an aspect of the invention;

FIG. 12A illustrates an example in which overlapping text and image objects have no distinctiveness according to an aspect of the invention;

FIG. 12B illustrates an example in which the text object of FIG. 12A having no distinctiveness is corrected by moving the position of the text object to a position below the image object of FIG. 12A so that the distinctiveness of the text object is enhanced according to an aspect of the invention; and

FIG. 12C illustrates an example of XHTML code for moving the position of the text object of FIG. 12A below the image object of FIG. 12A according to an aspect of the invention.

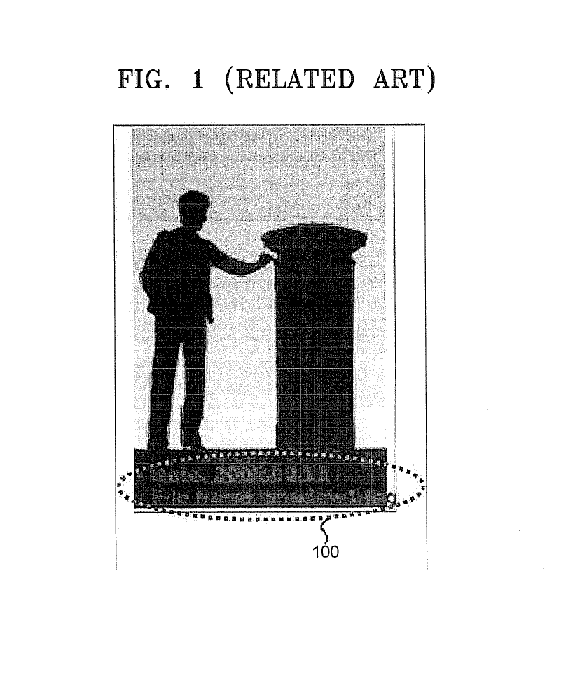

### DETAILED DESCRIPTION OF THE INVENTION

Reference will now be made in detail to embodiments of the invention, examples of which are illustrated in the accompanying drawings, wherein like reference numerals refer to like elements throughout. The embodiments are described below in order to explain the invention by referring to the figures.

It will be readily understood by a person skilled in the art that techniques applied to an XHTML-Print document as explained below can also be applied to an XHTML document or a document in another markup language

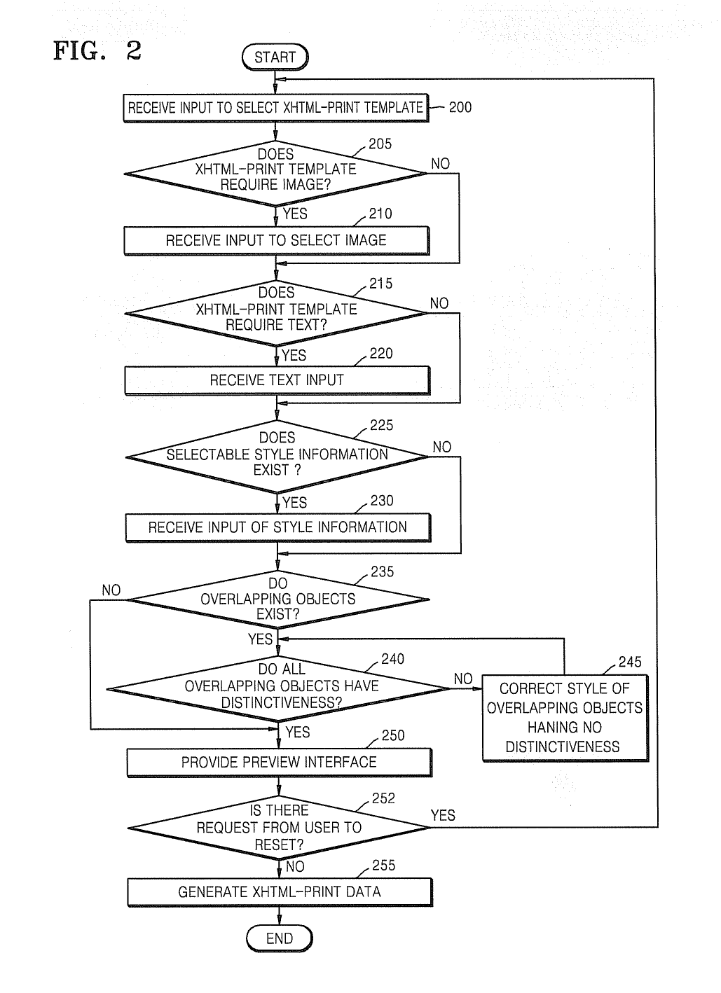

FIG. 2 is a flowchart of a method of generating XHTML data according to an aspect of the invention.

An input by a user of a device to select an XHTML-Print template is received in operation 200. Since the device stores XHTML-Print templates that are supported by the device, in order to support XHTML-Print data printing, a preview screen of the XHTML-Print template is provided and the device receives the input by the user to select an XHTML-Print template that the user wants to print in operation 200.

It is determined whether the XHTML-Print template requires an image in operation 205.

If it is determined in operation 205 that the XHTML-Print template requires an image, an input by the user to select an image from images stored in the device is received in operation 210.

If it is determined in operation 205 that the XHTML-Print template does not require an image, or if operation 210 has been performed, it is determined whether the XHTML-Print template requires an input of text in operation 215.

If it is determined in operation 215 that the XHTML-Print template requires text, a text input by the user is received in operation 220.

If it is determined in operation 215 that the XHTML-Print template does not require text, or if operation 220 has been performed, it is determined whether selectable style information exists in operation 225. Style information refers to text colors, background colors, cropping information, position information, and the like.

If it is determined in operation 225 that selectable style information exists, an input by the user of style information from predetermined style information selectable in the XHTML-Print template selected in operation 200 is received in operation 230.

If it is determined in operation 225 that selectable style information does not exist, or if operation 230 has been performed, it is determined whether overlapped objects exist in operation 235.

If it is determined in operation 235 that overlapping objects exist, it is determined whether all of the overlapping objects have distinctiveness in operation 240.

A method of determining whether an overlapping object has distinctiveness in operation 240 will now be explained.

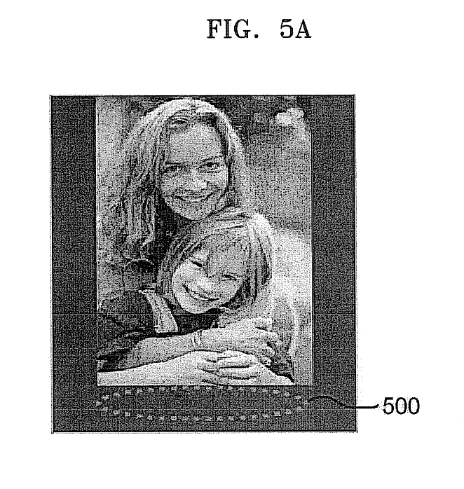

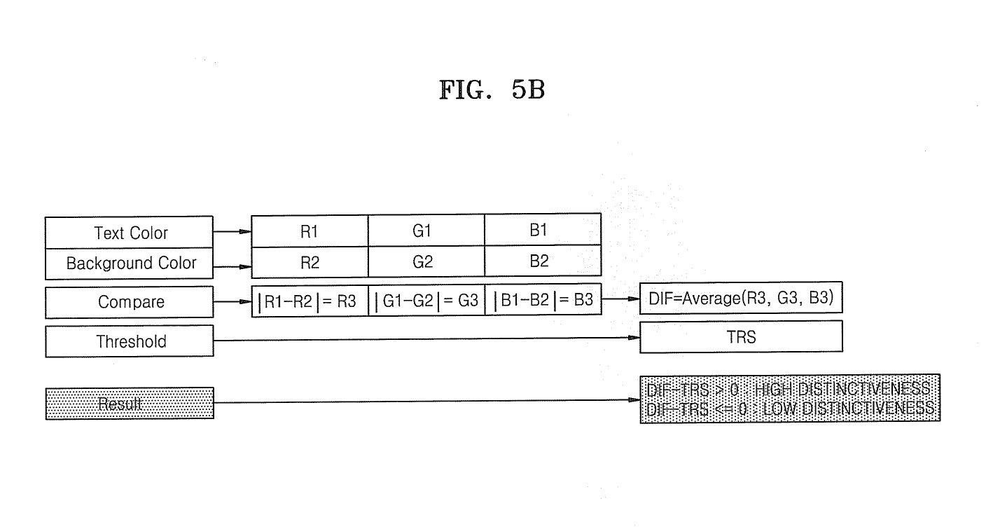

First, when a text object overlaps a background object as indicated by reference number 500 in FIG. 5A, the color value R1, G1, B1 of the text object is compared with the color value R2, G2, B2 of the overlapped background object, and if the difference DIF of the color values does not exceed a preset threshold value TRS, it is determined that it is difficult for a user to distinguish the text object from the background object and therefore the text object does not have distinctiveness, as illustrated in FIG. 5B.

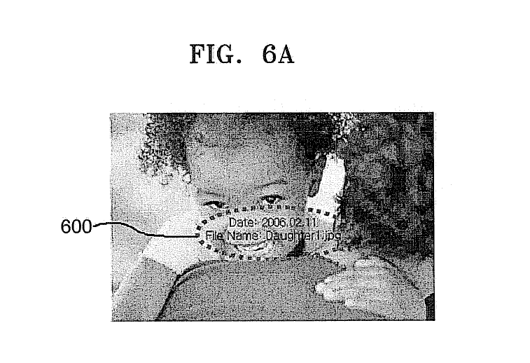

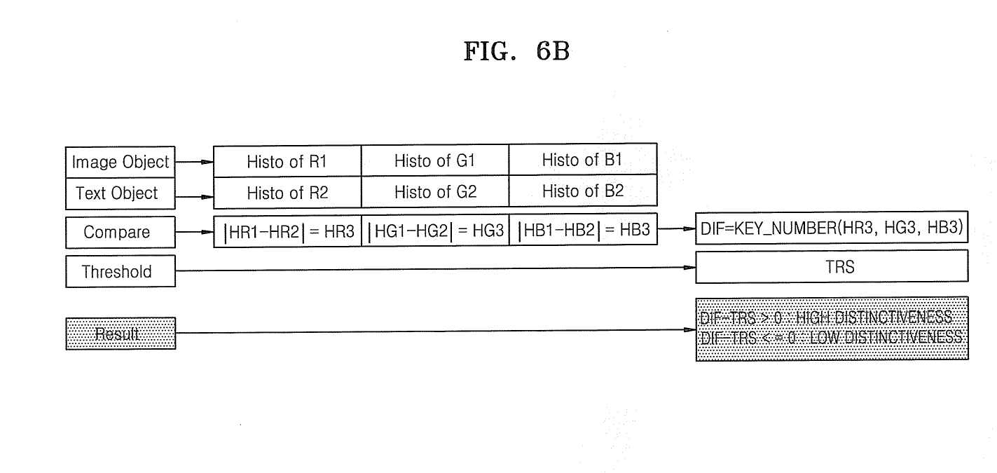

Second, when a text object overlaps an image object as indicated by reference number 600 in FIG. 6A, in relation to the overlapped image object, the number of pixels (histogram) DIF=KEY_NUMBER of the image area distributed in the color value of the text object is obtained, and if DIF does not exceed a preset threshold value TRS, it is determined that it is difficult for the user to distinguish the text object from the image object and therefore the text object does not have distinctiveness, as illustrated in FIG. 6B. KEY_NUMBER is the number of pixels existing in a predetermined area (a color range of the overlapped object) of a histogram. Alternatively, the average color value of the image object may be compared with the color value of the text object, and if the difference DIF of the color values does not exceed a preset threshold value TRS, it is determined that it is difficult for the user to distinguish the text object from the image object and therefore the text object does not have distinctiveness.

Referring back to FIG. 2, if it is determined in operation 240 that any of the overlapping objects do not have distinctiveness, the style of the overlapping objects having no distinctiveness is automatically corrected in operation 245.

A method of correcting the style of an object in operation 245 will now be explained.

First, the style of an object may be corrected by correcting the color of the object. When it is difficult to distinguish an object from a background, the color of the object may be corrected to be complementary to the color of the background.

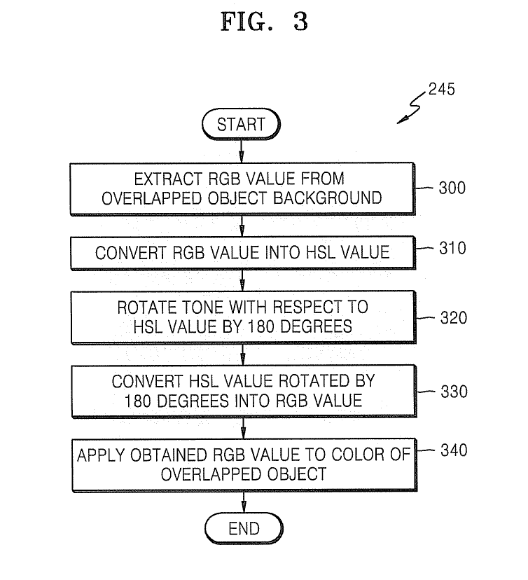

FIG. 3 is a flowchart of an operation of correcting the color of an object to be complementary to the color of a background according to an aspect of the invention. An RGB value is extracted from the background of an overlapped object in operation 300. The RGB value extracted in operation 300 is converted into an HSL value in operation 310. With respect to the HSL value obtained in operation 310, the tone is rotated by 180 degrees in operation 320. The HSL value rotated by 180 degrees in operation 320 is converted into an RGB value in operation 330. The RGB value obtained in operation 330 is applied to the color of the overlapped object in operation 340.

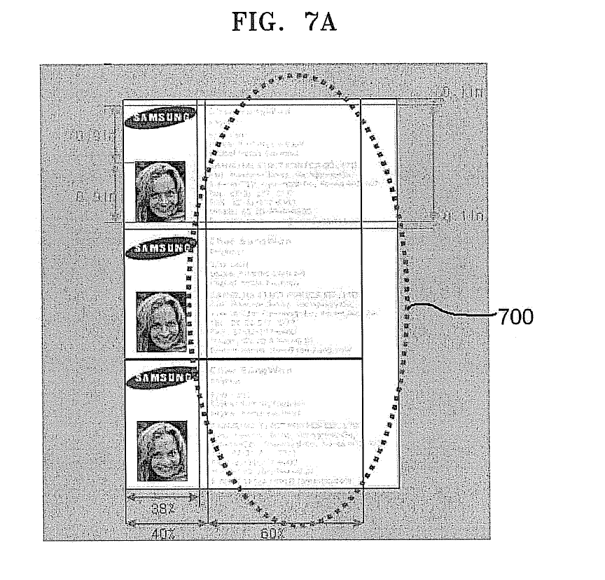

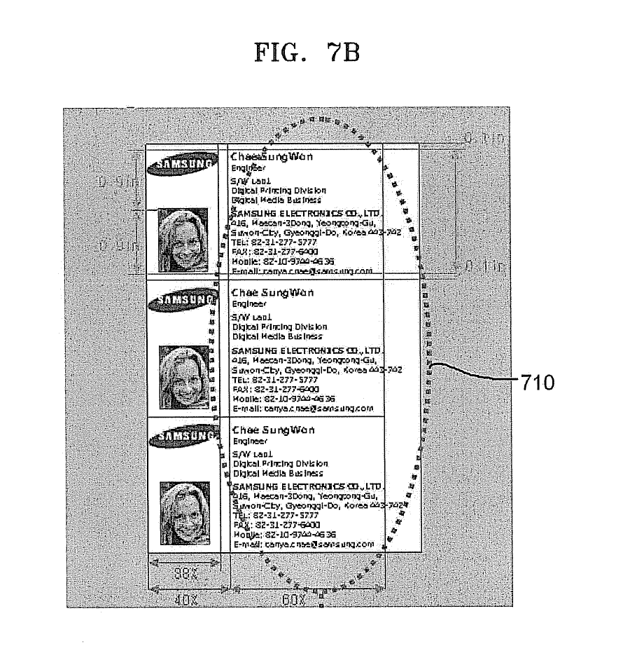

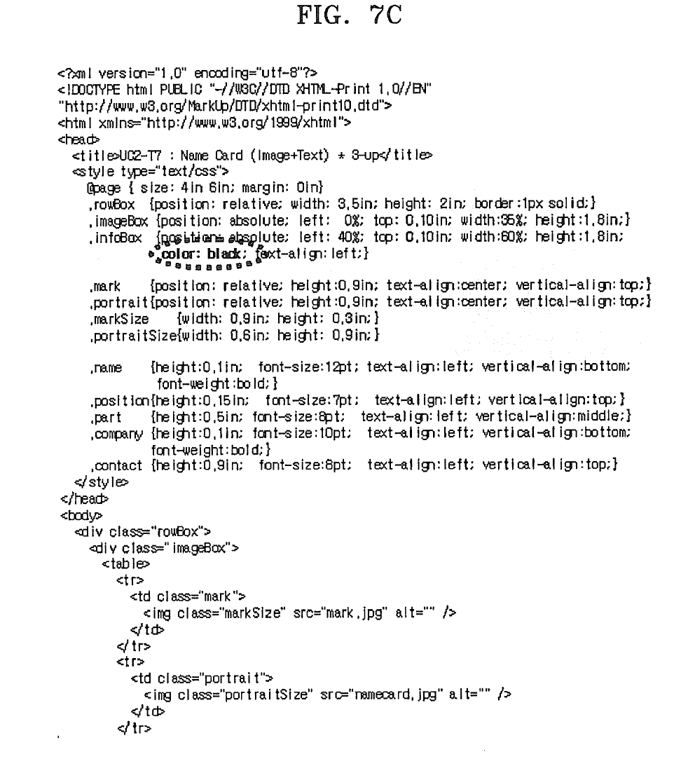

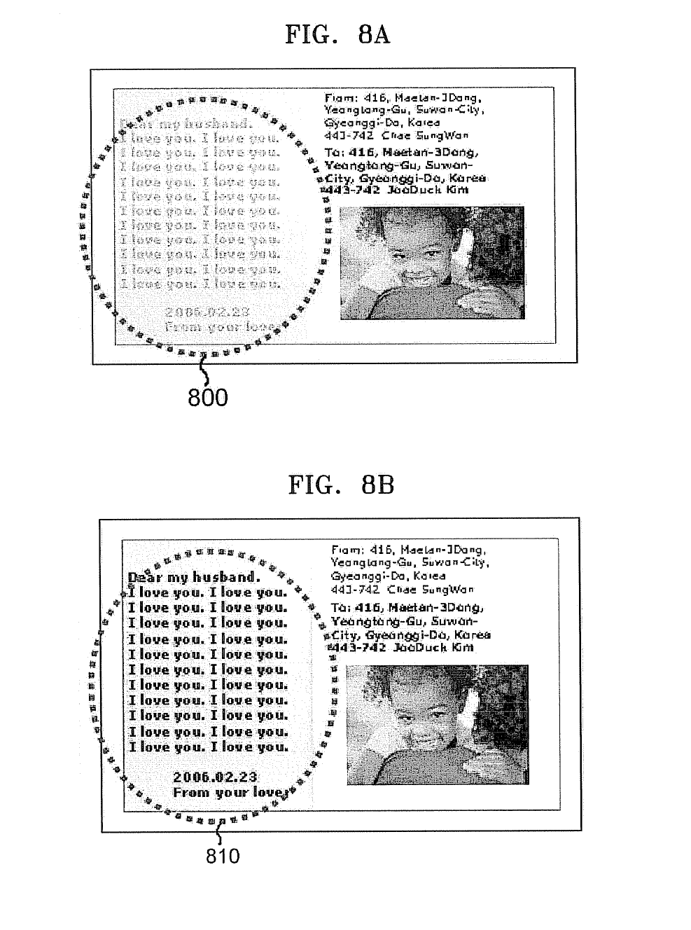

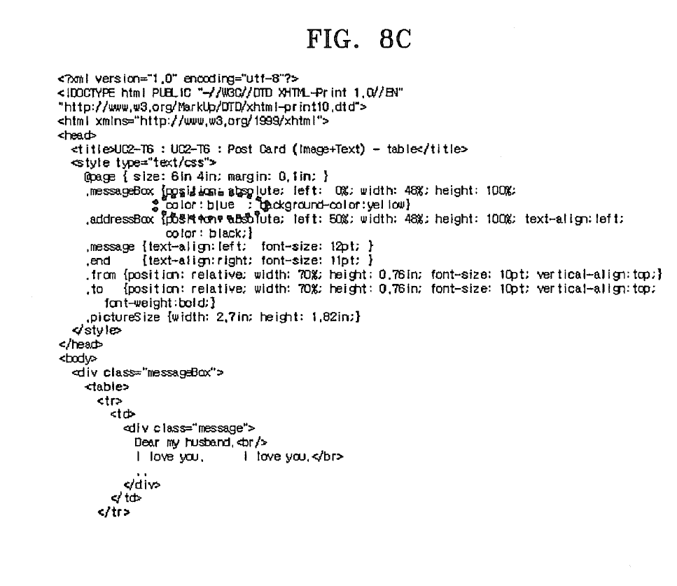

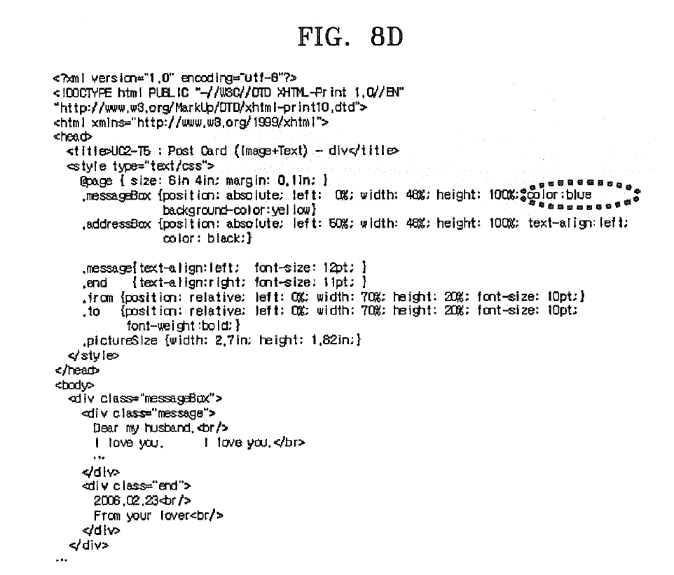

Reference numbers 700 in FIGS. 7A and 800 in FIG. 8A indicate text objects having no distinctiveness in relation to their backgrounds. According to the XHTML code indicated by the dotted lines in FIGS. 7C, 8C, and 8D, the colors of the text objects are corrected to be complementary to the colors of the backgrounds as indicated by reference numbers 710 in FIG. 7B and 810 in FIG. 8B so that the distinctiveness of the text objects is enhanced. In FIG. 8C, content is defined using a table, and in FIG. 8D, content is defined using a <div> tag. In FIG. 7C, the color of the text object is corrected from ‘yellow’ to ‘black’, and in FIGS. 8C and 8D, the color of the text object is corrected from ‘orange’ to ‘blue’.

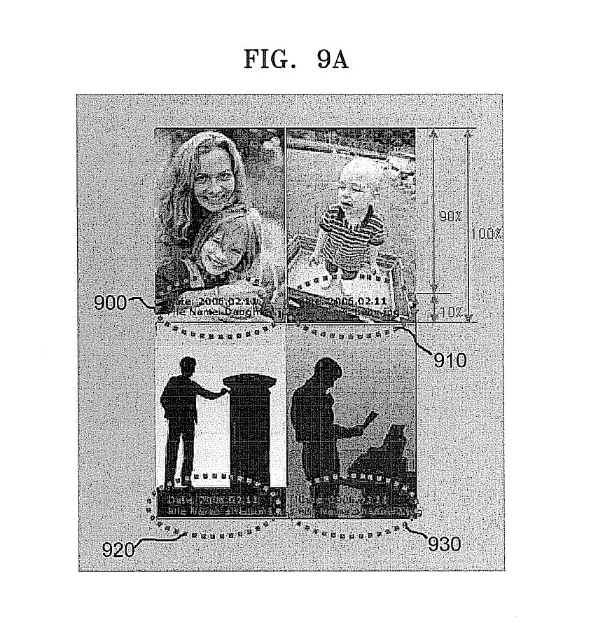

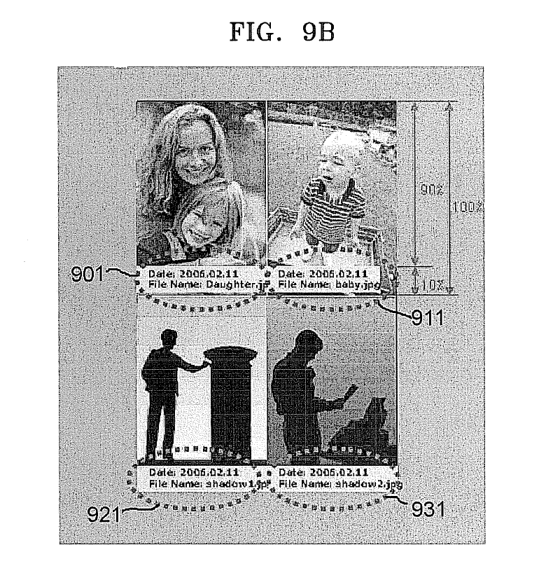

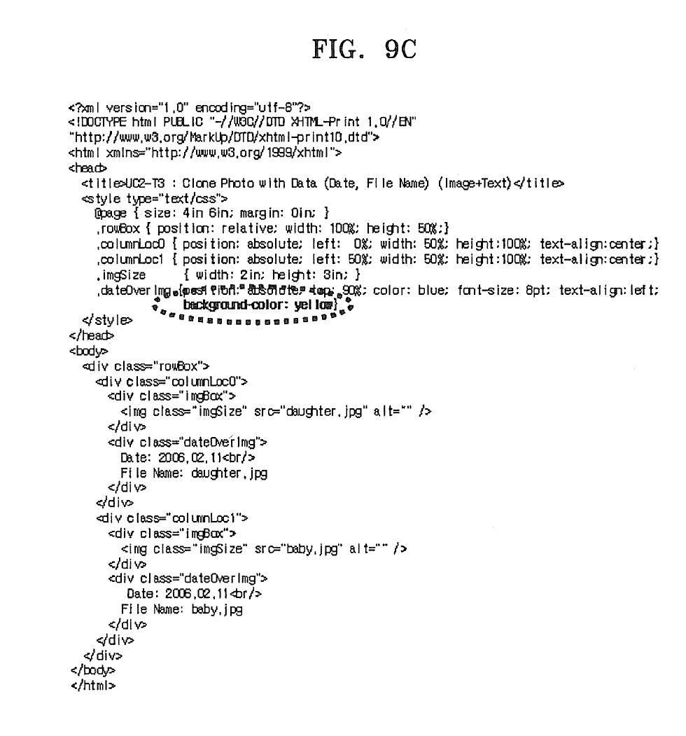

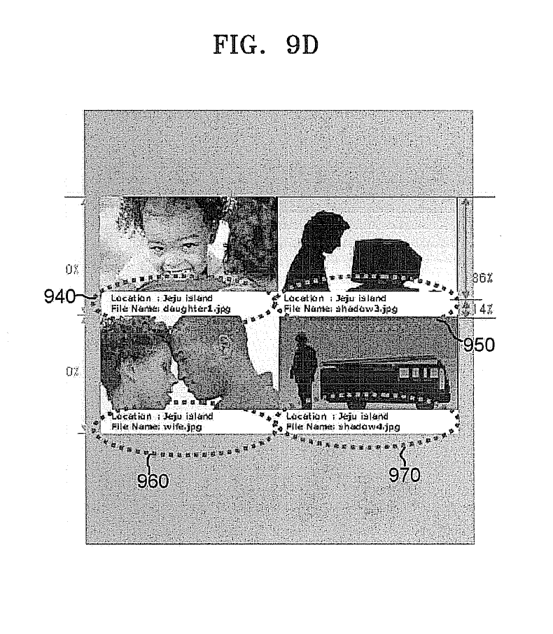

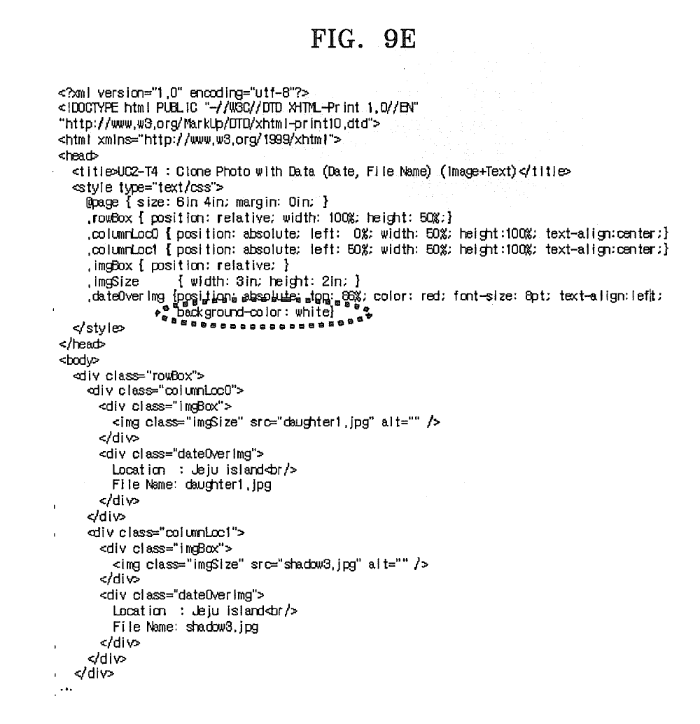

Second, the style of an object may be corrected by correcting the color of a background. When it is difficult to distinguish a text object from a background or a portion of an image object serving as a background, the distinctiveness of the text object can be enhanced by providing a color property to the background or changing the color of the background. Reference numbers 900, 910, 920, and 930 in FIG. 9A indicate text objects that are difficult to distinguish from portions of image objects serving as backgrounds. As indicated by the dotted lines in the XHTML code in FIG. 9C, the color of the background is corrected to ‘yellow’ as indicated by reference numbers 901, 911, 921, and 931 in FIG. 9B so that the distinctiveness of the text objects can be enhanced. Reference numbers 940, 950, 960, and 970 in FIG. 9D indicate another example in which the color of the background is corrected to ‘white’ as indicated by the dotted lines in the XHTML code in FIG. 9E so that the distinctiveness of the text objects is enhanced.

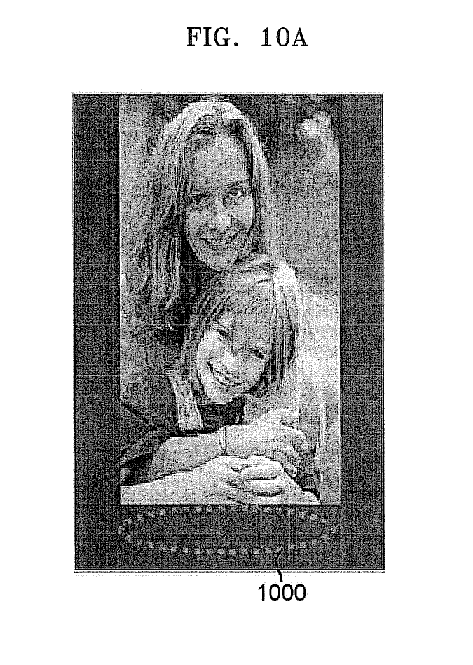

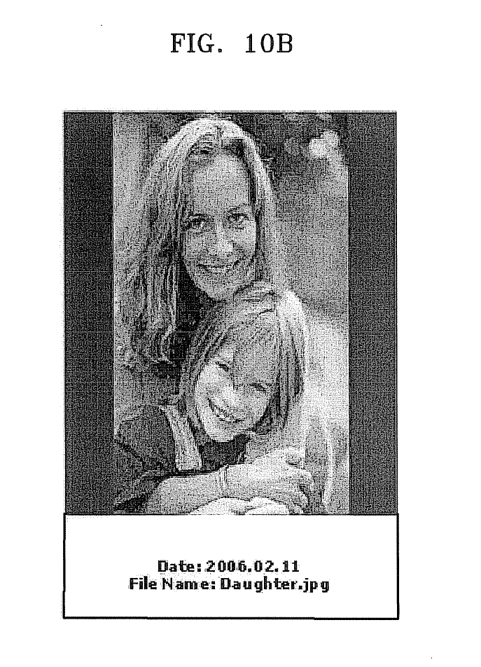

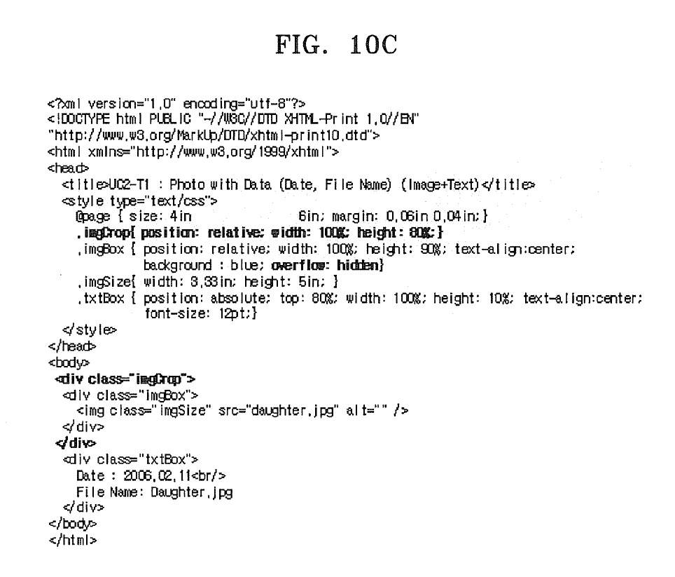

Third, the style of an object may be corrected by cropping the object. By cropping a part of an overlapped object having no distinctiveness, distinctiveness of the object can be enhanced. Reference number 1000 in FIG. 10A indicates an area having no distinctiveness because of overlapping text and image objects. By cropping 20% of the image object at the bottom of the image object as indicated in the XHTML code in FIG. 10C, the image object is corrected as illustrated in FIG. 10B so that the distinctiveness of the text object is enhanced.

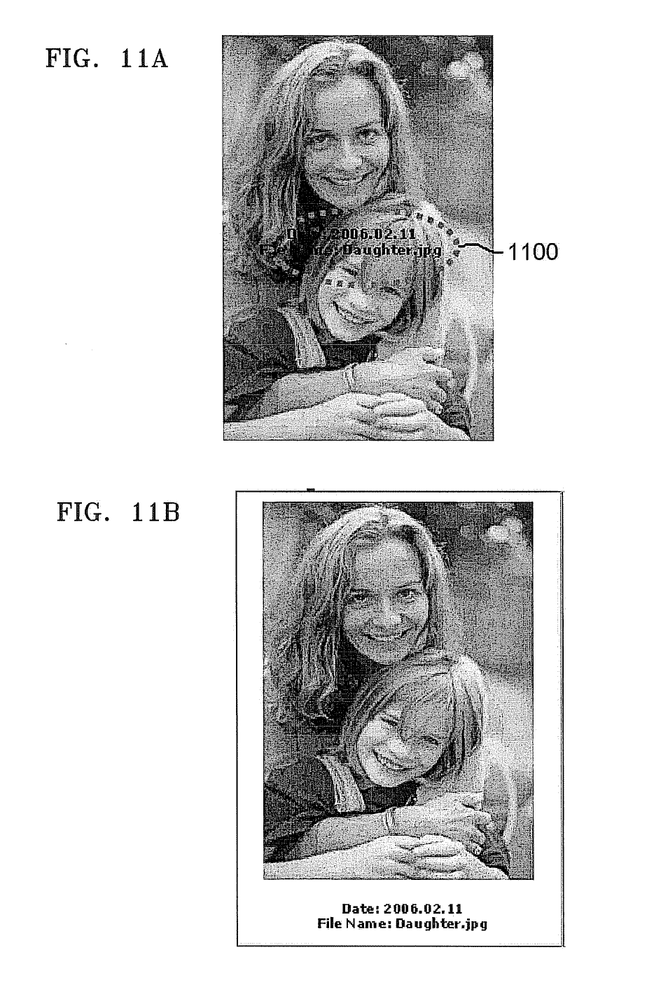

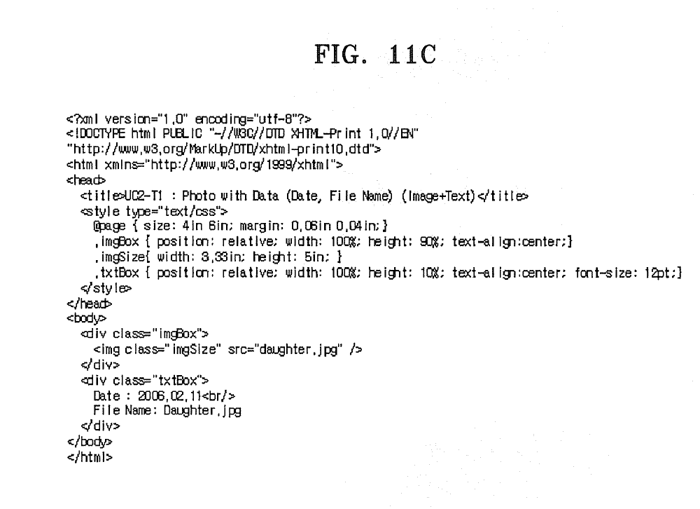

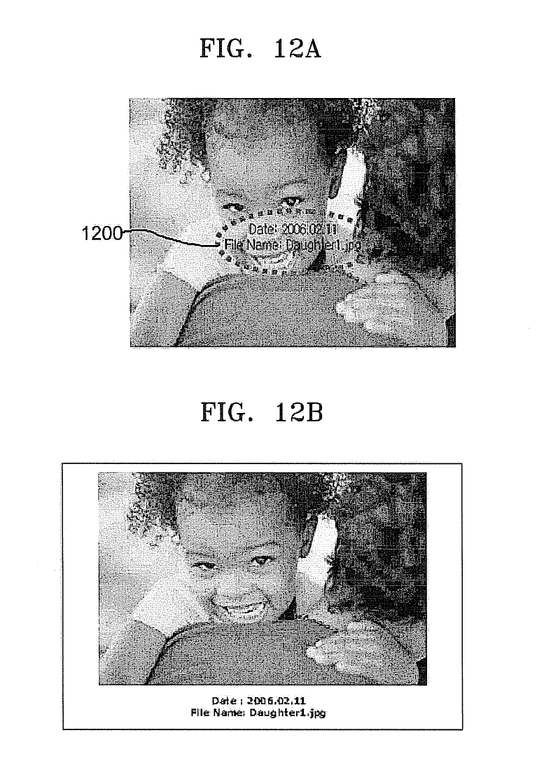

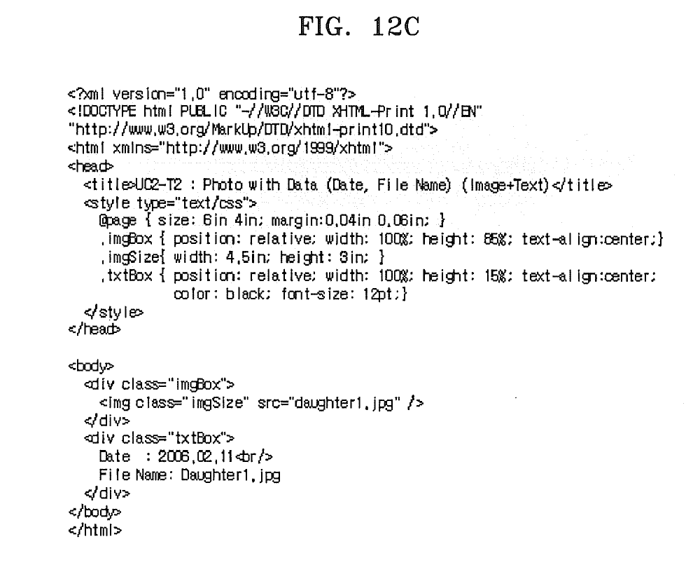

Fourth, the style of an object may be corrected by moving the position of the object. By moving a position of an overlapped object having no distinctiveness, distinctiveness of the object can be enhanced. Reference numbers 1100 in FIGS. 11A and 1200 in FIG. 12A indicate areas having no distinctiveness because of overlapping text and image objects. By moving the positions of the text objects to positions below the image objects as indicated in the XHTML code in FIGS. 11C and 12C, the text objects are corrected as illustrated in FIGS. 11B and 12B so that the distinctiveness of the text objects is enhanced.

Referring back to FIG. 2, if it is determined in operation 235 that no overlapping objects exist, or it is determined in operation 240 that all overlapping objects have distinctiveness, a preview interface is provided in operation 250. The preview interface displays to the user a result of correcting the style of any overlapping object having no distinctiveness whose style was corrected in operation 245 so that the user can see the result before printing.

It is determined in operation 252 whether there is a request from the user to reset the result displayed through the preview interface provided in operation 250.

If it is determined in operation 252 that there is not a request from the user to reset the result, XHTML-Print data is generated in operation 255. In operation 255, the image selected in operation 210 is linked to the XHTML-Print template selected in operation 200, the text input in operation 220 is written into the XHTML-Print template, and the style of any overlapping object corrected in operation 245 is applied to the XHTML-Print template.

If it is determined in operation 252 that there is a request from the user to reset the result, an input of the user to select an XHTML-Print template is received in operation 200.

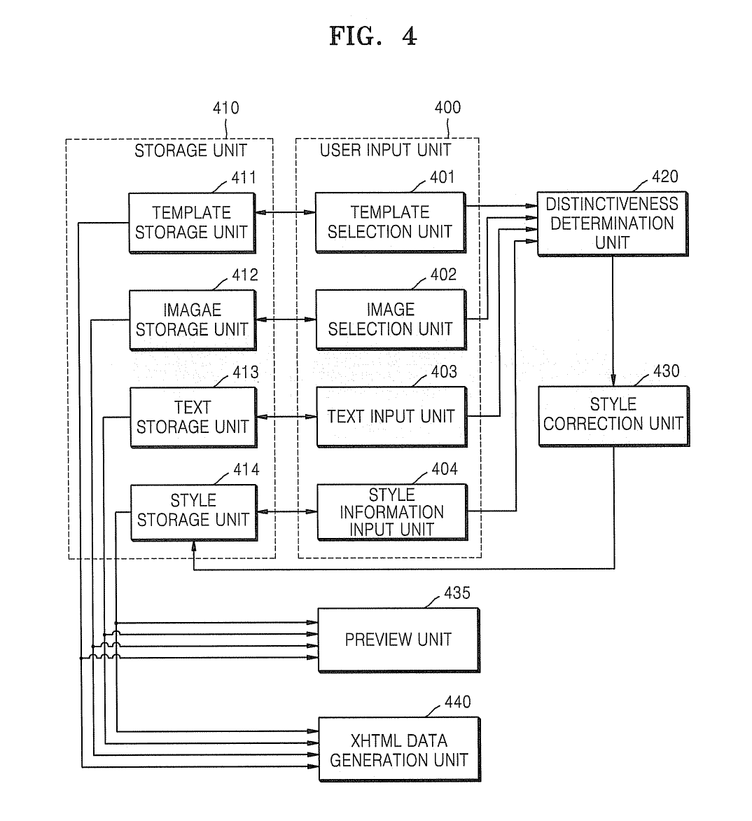

FIG. 4 is a block diagram of an XHTML data generation apparatus according to an aspect of the invention. The XHTML data generation apparatus includes a user input unit 400, a storage unit 410, a distinctiveness determination unit 420, a style correction unit 430, a preview unit 435, and an XHTML data generation unit 440.

The user input unit 400 receives user inputs of information to generate XHTML-Print data. The user input unit 400 includes a template selection unit 401, an image selection unit 402, a text input unit 403, and a style information input unit 404.

The template selection unit 401 receives a user input to select a predetermined XHTML-Print template from XHTML-Print templates stored in the template storage unit 411. The template selection unit 401 provides a preview screen of an XHTML-Print template to the user so that a user input to select an XHTML-Print template desired to be printed is received.

If the XHTML-Print template requires an image, the image selection unit 402 receives a user input to select an image desired to be printed from images stored in the image storage unit 412.

If the XHTML-Print template requires a text input, the text input unit 403 receives a user input of text desired to be printed, and the input text is written in the text storage unit 413.

If selectable style information exists, the style information input unit 404 receives a user input of style information from predetermined style information selectable in the XHTML-Print template selected by the user using the template selection unit 401, and the input style information is stored in the style storage unit 414. Style information refers to text colors, background colors, cropping information, position information, and the like.

The storage unit 410 includes the template storage unit 411, the image storage unit 412, the text storage unit 413, and the style storage unit 414.

The template storage unit 411 stores XHTML-Print templates to support XHTML-Print data printing, and stores information on the XHTML-Print template selected by the user using the template selection unit 401.

The image storage unit 412 stores image data, and stores information on the image selected by the user using the image selection unit 402.

The text storage unit 413 stores the text input by the user using the text input unit 403.

The style information storage unit 414 stores the style information input by the user using the style information input unit 404.

The distinctiveness determination unit 420 determines whether overlapping objects exist, and if it determines that overlapping objects do exist, it determines whether all of the overlapping objects have distinctiveness.

A method of determining distinctiveness in the distinctiveness determination unit 420 will now be explained.

First, when a text object overlaps a background object as indicated by reference number 500 in FIG. 5A, the color value R1, G1, B1 of the text object is compared with the color value R2, G2, B2 of the overlapped background object, and if the difference DIF of the color values does not exceed a preset threshold value TRS, it is determined that it is difficult for a user to distinguish the text object from the background object and therefore the text object does not have distinctiveness, as illustrated in FIG. 5B.

Second, when a text object overlaps an image object as indicated by reference number 600 in FIG. 6A, in relation to the overlapped image object, the number of pixels (histogram) DIF-KEY_NUMBER of the image area distributed in the color value of the text object is obtained, and if DIF does not exceed a present threshold value TRS, it is determined that it is difficult for the user to distinguish the text object from the image object and therefore the text object does not have distinctiveness, as illustrated in FIG. 6B. KEY_NUMBER is the number of pixels existing in a predetermined area (a color range of the overlapped object) of a histogram. Alternatively, the average color value of the image object may be compared with the color value of the text object, and if the difference DIF of the color values does not exceed a preset threshold value TRS, it is determined that it is difficult for the user to distinguish the text object from the image object and therefore the text object does not have distinctiveness.

The style correction unit 430 automatically corrects the style of any overlapping object that is determined to have no distinctiveness in the distinctiveness determination unit 420.

A method of correcting the style of an object in the style correction unit 430 will now be explained.

First, the style of an object may be corrected by correcting the color of the object. When it is difficult to distinguish an object from a background, the color of the object may be corrected to be complementary to the color of the background.

FIG. 3 is a flowchart of an operation of correcting the color of an object to be complementary to the color of a background according to an aspect of the invention. An RGB value is extracted from the background of an overlapped object in operation 300. The RGB value extracted in operation 300 is converted into an HSL value in operation 310. With respect to the HSL value obtained in operation 310, the tone is rotated by 180 degrees in operation 320. The HSL value rotated by 180 degrees in operation 320 is converted into an RGB value in operation 330. The RGB value obtained in operation 330 is applied to the color of the overlapped object in operation 340.

Reference numbers 700 in FIGS. 7A and 800 in FIG. 8A indicate text objects having no distinctiveness in relation to their backgrounds. According to the XHTML code indicated by the dotted lines in FIGS. 7C, 8C, and 8D, the colors of the text objects are corrected to be complementary to the colors of the backgrounds as indicated by reference numbers 710 in FIG. 7B and 810 in FIG. 8B so that the distinctiveness of the text objects is enhanced. In FIG. 8C, content is defined using a table, and in FIG. 8D, content is defined using a <div> tag. In FIG. 7C, the color of the text object is corrected from ‘yellow’ to ‘black’, and in FIGS. 8C and 8D, the color of the text object is corrected from ‘orange’ to ‘blue’.

Second, the style of an object may be corrected by correcting the color of a background. When it is difficult to distinguish a text object from a background or a portion of an image object serving as a background, the distinctiveness of the text object can be enhanced by providing a color property to the background or changing the color of the background. Reference numbers 900, 910, 920, and 930 in FIG. 9A indicate text objects that are difficult to distinguish from portions of image objects serving as backgrounds. As indicated by the dotted lines in the XHTML code in FIG. 9C, the color of the background is corrected to ‘yellow’ as indicated by reference numbers 901, 911, 921, and 931 in FIG. 9B so that the distinctiveness of the text objects can be enhanced. Reference numbers 940, 950, 960, and 970 in FIG. 9D indicate another example in which the color of the background is corrected to ‘white’ as indicated by the dotted lines in the XHTML code in FIG. 9E so that the distinctiveness of the text objects is enhanced.

Third, the style of an object may be corrected by cropping the object. By cropping part of an overlapped object having no distinctiveness, distinctiveness of the object can be enhanced. Reference number 1000 in FIG. 10A indicates an area having no distinctiveness because of overlapping text and image objects. By cropping 20% of the image object at the bottom of the image object as indicated in the XHTML code in FIG. 10C, the image object is corrected as illustrated in FIG. 10B so that the distinctiveness of the text object is enhanced.

Fourth, the style of an object may be corrected by moving the position of the object. By moving a position of an overlapped object having no distinctiveness, distinctiveness of the object can be enhanced. Reference numbers 1100 in FIGS. 11A and 1200 in FIG. 12A indicate areas having no distinctiveness because of overlapping text and image objects. By moving the positions of the text objects to positions below the image objects as indicated in the XHTML code in FIGS. 11C and 12C, the text objects are corrected as illustrated in FIGS. 11B and 12B so that the distinctiveness of the text objects is enhanced.

Referring back to FIG. 4, corrected style information of the style of any overlapping object having no distinctiveness whose style was corrected in the style correction unit 430 is stored in the style storage unit 414. The preview unit 435 provides a preview interface that displays to the user a result of correcting the style of any overlapping object having no distinctiveness whose style was corrected in the style correction unit 430 based on the data stored in the template storage unit 411, the image storage unit 412, the text storage unit 413, and the style information storage unit 414 so that the user can see the result before printing. If the user is not satisfied with the result displayed by the preview interface provided by the preview unit 435, the preview interface enables the user to request that the style of any overlapping object having no distinctiveness whose style was corrected in the style correction unit 430 be re-corrected in the style correction unit 430.

The XHTML data generation unit 440 generates XHTML-Print data based on the data stored in the template storage unit 411, the image storage unit 412, the text storage unit 413, and the style information storage unit 414. The XHTML data generation unit 440 links the image selected using the image selection unit 402 to the XHTML-Print template selected using the template selection unit 401, writes the text input using the text input unit 403 in the XHTML-Print template, and applies the style of any overlapping object as corrected in the style correction unit 430 to the XHTML-Print template.

Aspects of the invention can also be embodied as a computer readable medium encoded with processing instructions for implementing a method of generating XHTML data according to aspects of the invention performed by a computer. The computer readable medium may be any data storage device that can store data which can be thereafter read by a computer, such as read-only memory (ROM), random-access memory (RAM), CD-ROMs, magnetic tapes, floppy disks, and optical data storage devices. Also, aspects of the invention may also be embodied in computer-readable code embodied as a computer data signal in a carrier wave, or as data transmitted over a network, such as the Internet.

An XHTML data generation method and apparatus according to an aspect of the invention detects an overlapping object having low distinctiveness in XHTML-Print data generated by a device, automatically corrects the style of the overlapping object so that the distinctiveness of the overlapping object is enhanced, and applies the corrected style to the XHTML-Print data to generate corrected XHTML-Print data.

The generation of the corrected XHTML-Print data enhances the quality of printing. Also, the automatic correcting of the style does not require a user's input, thereby making the device convenient for the user to use. Furthermore, since a user interface or a preview screen for the user to directly correct data is not provided in a device with limited resources, the use of the limited resources is reduced so that the performance of the device can be improved.

Although several embodiments of the invention have been shown and described, it would be appreciated by those skilled in the art that changes may be made in these embodiments without departing from the principles and spirit of the invention, the scope of which is defined in the claims and their equivalents.

What is claimed is:

1. A method of generating extensible hypertext markup language (XHTML) data in a device generating XHTML data, the method comprising:
determining whether overlapping objects exist in XHTML data generated by the device;
determining whether all of the overlapping objects have distinctiveness; and
correcting a style of at least one overlapping object determined not to have distinctiveness among the overlapping objects.

2. The method of claim 1, further comprising applying the corrected style of the at least one overlapping object to the XHTML data to generate corrected XHTML data.

3. The method of claim 1, wherein the correcting of the style comprises correcting a color of the at least one overlapping object.

4. The method of claim 3, wherein the correcting of the color comprises correcting the color of the at least one overlapping object to be complementary to a color of a background of the at least one overlapping object.

5. The method of claim 1, wherein the correcting of the style comprises correcting a background of the at least one overlapping object.

6. The method of claim 1, wherein the correcting of the style comprises cropping the at least one overlapping object.

7. The method of claim 1, wherein the correcting of the style comprises moving a position of the at least one overlapping object.

8. The method of claim 1, wherein the correcting of the style comprises automatically correcting the style of the at least one overlapping object without requiring an input from a user of the device.

9. The method of claim 1, wherein the determining of whether all of the overlapping objects have distinctiveness comprises comparing a color value of each one of the overlapping objects with a color value of each other one of the overlapping objects that overlaps the each one of the overlapping objects.

10. The method of claim 1, wherein the correcting of the style comprises correcting the style of a sufficient number of the overlapping objects so that all of the overlapping objects have distinctiveness.

11. The method of claim 1, wherein the XHTML data generated by the device is generated in response to at least one input from a user of the device.

12. A computer readable medium encoded with processing instructions for implementing the method of claim 1 performed by a computer.

13. An apparatus for generating extensible hypertext markup language (XHTML) data in a device generating XHTML data, the apparatus comprising:
a distinctiveness determination unit that determines whether overlapping objects exist in XHTML data generated by the device, and determines whether all of the overlapping objects have distinctiveness;
a style correction unit that corrects a style of at least one overlapping object determined not to have distinctiveness among the overlapping objects; and
an XHTML data generation unit that applies the corrected style of the at least one overlapping object to the XHTML data to generate corrected XHTML data.

14. The apparatus of claim 13, wherein the style correction unit corrects the style by correcting a color of the at least one overlapping object.

15. The apparatus of claim 14, wherein the style correction unit corrects the color by correcting the color of the at least one overlapping object to be complementary to a color of a background of the at least one overlapping object.

16. The apparatus of claim 13, wherein the style correction unit corrects the style by correcting a background of the at least one overlapping object.

17. The apparatus of claim 13, wherein the style correction unit corrects the style by cropping the at least one overlapping object.

18. The apparatus of claim 13, wherein the style correction unit corrects the style by moving a position of the at least one overlapping object.

19. The apparatus of claim 13, wherein the style correction unit corrects the style by automatically correcting the style of the at least one overlapping object without requiring an input from a user of the device.

20. The apparatus of claim 13, wherein the distinctiveness determination unit determines whether all of the overlapping objects have distinctiveness by comparing a color value of each one of the overlapping objects with a color value of each other one of the overlapping objects that overlaps the each one of the overlapping objects.

21. The apparatus of claim 13, wherein the style correction unit corrects the style by correcting the style of a sufficient number of the overlapping objects so that all of the overlapping objects have distinctiveness.

22. The apparatus of claim 13, wherein the XHTML data generated by the device is generated in response to at least one input from a user of the device.

23. A method of generating extensible hypertext markup language (XHTML) data in a device generating XHTML data, the method comprising:
determining whether all of overlapping objects existing in XHTML data generated by the device have distinctiveness;
automatically correcting a style of a sufficient number of the overlapping objects so that all of the overlapping objects have distinctiveness; and
applying the corrected style of the sufficient number of the overlapping objects to the XHTML data to generate corrected XHTML data.

24. The method of claim 23, wherein the overlapping objects comprise a text object overlapping a background object;
wherein the text object does not have distinctiveness relative to the background object; and
wherein the automatically correcting of the style comprises correcting the style of the text object or the background object so that the text object has distinctiveness relative to the background object.

25. The method of claim 24, wherein the correcting of the style of the text object or the background object comprises correcting a color of the text object or the background object so that the text object has distinctiveness relative to the background object.

26. The method of claim 25, wherein the correcting of the color of the text object or the background object comprises correcting the color of the text object to be a color that is complementary to the color of the background object.

27. The method of claim 25, wherein the correcting of the color of the text object or the background object comprises correcting the color of the background object to be a color that makes the text object have distinctiveness relative to the background object.

28. The method of claim 27, wherein the color of the background object that makes the text object have distinctiveness relative to the background object is a color that is complementary to the color of the text object.

29. The method of claim 23, wherein the overlapping objects comprise a text object overlapping an image object;
wherein the text object does not have distinctiveness relative to the image object; and
wherein the automatically correcting of the style comprises correcting the style of the text object or the image object so that the text object has distinctiveness relative to the image object.

30. The method of claim 29, wherein the correcting of the style of the text object or the image object comprises correcting a color of a portion of the image object serving as a background of the text object so that the text object has distinctiveness relative to the portion of the image object.

31. The method of claim 30, wherein the correcting of the color of the portion of the image object comprises correcting the color of the portion of the image object to be a color that makes the text object have distinctiveness relative to the portion of the background object.

32. The method of claim 31, wherein the color of the portion of the image object that makes the text object have distinctiveness relative to the portion of the image object is a color that is complementary to the color of the text object.

33. The method of claim 29, wherein the correcting of the style of the text object or the image object comprises cropping the image object so that the text object does not overlap the image object.

34. The method of claim 29, wherein the correcting of the style of the text object or the image object comprises moving a position of the text object so that the text object does not overlap the image object.

35. The method of claim 23, further comprising providing a preview interface that displays to the user of the device a result of the automatically correcting of the style so that the user can see the result before printing the corrected XHTML data.

36. The method of claim 23, wherein the method does not comprise providing a preview interface that displays to the user of the device a result of the automatically correcting of the style so that the user can see the result before printing the corrected XHTML data to reduce use of resources of the device, thereby improving performance of the device.

37. The method of claim 23, where the automatically correcting of the style is performed without requiring an input from a user of the device.

38. An apparatus for generating extensible hypertext markup language (XHTML) data in a device generating XHTML data, the apparatus comprising:
a distinctiveness determination unit that determines whether all of overlapping objects existing in XHTML data generated by the device have distinctiveness;
a style correction unit that automatically corrects a style of a sufficient number of the overlapping objects so that all of the overlapping objects have distinctiveness without requiring an input from a user of the device; and
an XHTML data generation unit that applies the corrected style of the sufficient number of the overlapping objects to the XHTML data to generate corrected XHTML data.

39. The apparatus of claim 38, wherein the overlapping objects comprise a text object overlapping a background object;
wherein the text object does not have distinctiveness relative to the background object; and
wherein the style correction unit corrects the style of the text object or the background object so that the text object has distinctiveness relative to the background object.

40. The apparatus of claim 39, wherein the style correction unit corrects the style of the text object or the background object by correcting a color of the text object or the background object so that the text object has distinctiveness relative to the background object.

41. The apparatus of claim 40, wherein the style correction unit corrects the color of the text object or the background object by correcting the color of the text object to be a color that is complementary to the color of the background object.

42. The apparatus of claim 40, wherein the style correction unit corrects the color of the text object or the background object by correcting the color of the background object to be a color that makes the text object have distinctiveness relative to the background object.

43. The apparatus of claim 42, wherein the color of the background object that makes the text object have distinctiveness relative to the background object is a color that is complementary to the color of the text object.

44. The apparatus of claim 38, wherein the overlapping objects comprise a text object overlapping an image object;
wherein the text object does not have distinctiveness relative to the image object; and
wherein the style correction unit corrects the style of the text object or the image object so that the text object has distinctiveness relative to the image object.

45. The apparatus of claim 44, wherein the style correction unit corrects the style by correcting a color of a portion of the image object serving as a background of the text object so that the text object has distinctiveness relative to the portion of the image object.

46. The apparatus of claim 45, wherein the style correction unit corrects the color of the portion of the image object by correcting the color of the portion of the image object to be a color that makes the text object have distinctiveness relative to the portion of the background object.

47. The apparatus of claim 46, wherein the color of the portion of the image object that makes the text object have distinctiveness relative to the portion of the image object is a color that is complementary to the color of the text object.

48. The apparatus of claim 44, wherein the style correction unit corrects the style by cropping the image object so that the text object does not overlap the image object.

49. The apparatus of claim 44, wherein the style correction unit corrects the style by moving a position of the text object so that the text object does not overlap the image object.

50. The apparatus of claim 38, further comprising a preview unit that provides a preview interface that displays to the user of the device a result of the automatically correcting of the style performed by the style correction unit so that the user can see the result before printing the corrected XHTML data.

51. The apparatus of claim 38, wherein the apparatus does not comprise a preview unit that provides a preview interface that displays to the user of the device a result of the automatically correcting of the style performed by the style correction unit so that the user can see the result before printing the corrected XHTML to reduce use of resources of the device, thereby improving performance of the device.

52. The apparatus of claim 38, where the style correction unit automatically corrects the style without requiring an input from a user of the device.
